(19) United States
(12) Patent Application Publication
(10) Pub. No.: US 2008/0105007 A1
(43) Pub. Date: May 8, 2008

(54) Electronic device locking system

(76) Inventors: Mark S. Tracy, Tomball, TX (US); Paul J. Doczy, Cypress, TX (US); Earl W. Moore, Cypress, TX (US); Steven S. Homer, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,981

(22) Filed: Nov. 2, 2006

(51) Int. Cl. E05B 73/00

(52) U.S. Cl. 70/58

(57) ABSTRACT

An electronic device locking system comprises a locking element removably coupleable to an electronic device and a locking cable coupled to the locking element to enable at least three degrees of freedom of movement of the locking cable relative to the locking element.

### BACKGROUND OF THE INVENTION

Security locking systems are used to reduce incidents of theft of electronic devices. Such systems commonly include a locking element coupleable and lockable to a portion of the electronic device (e.g., coupleable to notebook computer). A security cable is connected to the locking element to enable the electronic device to be securely fastened to structures such as, but not limited to, tables or shelves, to prevent unauthorized removal of the notebook computer from such location. For example, such security locking systems are commonly used inside retail stores to prevent unauthorized removal of electronic devices from display shelves. However, the position and/or orientation of the security cable and locking element relative to the electronic device sometimes enables enough leverage to be applied to pry or break-away the locking system from the electronic device.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a diagram illustrating an embodiment of an electronic device locking system; and

FIG. 2 is a top view of the electronic device locking system of FIG. 1.

### DETAILED DESCRIPTION OF THE DRAWINGS

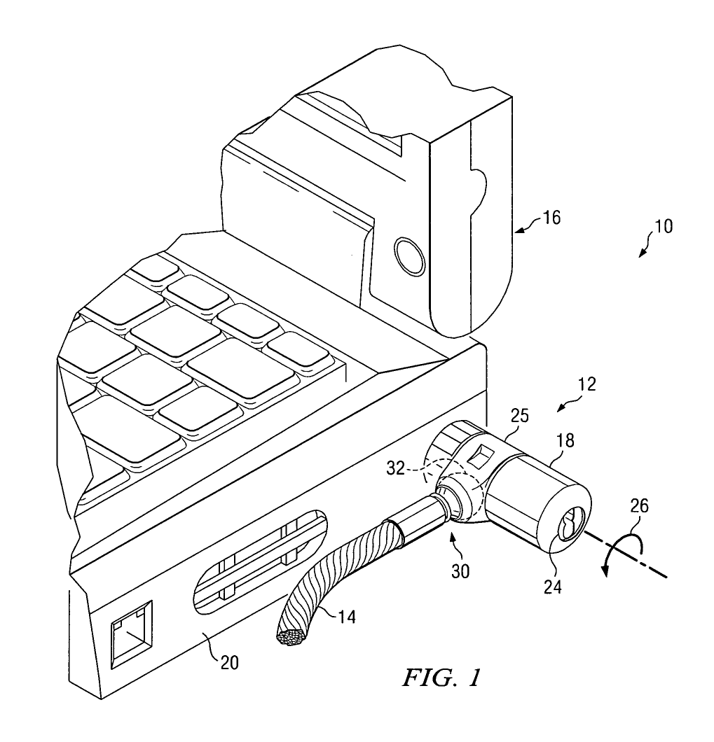

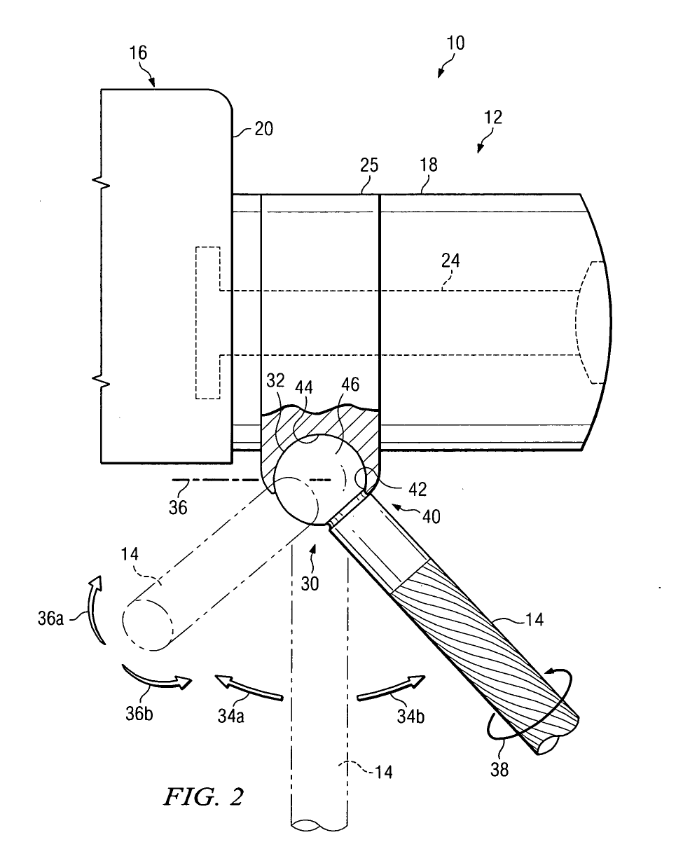

The preferred embodiments of the present invention and the advantages thereof are best understood by referring to FIGS. 1 and 2 of the drawings, like numerals being used for like and corresponding parts of the various drawings.

FIG. 1 is a diagram illustrating an embodiment of an electronic device locking system 12 used for securing and/or otherwise preventing unauthorized removal of an electronic device 10 from a particular location. In the embodiment illustrated in FIG. 1, locking system 12 is illustrated as being used in connection with a laptop or notebook computer 16 type of electronic device 12; however, it should be understood that locking system 12 may be used with other types of electronic devices 12 such as, but not limited to, tablet personal computers, personal digital assistants, desktop computer devices, or any other type of portable or non-portable electronic device. In the embodiment illustrated in FIG. 1, system 12 comprises a pivotally and rotatably mounted locking cable 14. In FIG. 1, locking cable 14 is pivotally and rotatably coupled to a locking element 18. In operation, locking cable 14 is secured to a shelf, desk, wall, weight, floor or other structure adjacent to or on which electronic device 10 is supported in order to prevent unauthorized removal of electronic device 10 from such location.

In the embodiment illustrated in FIG. 1, locking element 18 is removably coupleable to electronic device 10. In some embodiments, locking device 18 is coupled directly to a housing 20 of electronic device 10 (e.g., extending through an opening formed in housing 20). However, it should be understood the locking element 18 may be otherwise coupled to electronic device 10. Further, it should be understood that locking element 18 may be coupleable to any other portion or extension of electronic device 10. Locking element 18 comprises a lock 24 to securely fasten locking element 18 to electronic device 10. In the embodiment illustrated in FIG. 1, lock 24 comprises a key-based lock 24; however, it should be understood that lock 24 may comprise other types of locking mechanisms (e.g., a combination lock).

In the embodiment illustrated in FIG. 1, locking cable 14 comprises a steel cable; however, it should be understood that cable 14 may be otherwise configured (e.g., a fiber rope). In the embodiment illustrated in FIG. 1, locking cable 14 is secured to a sleeve 25 of locking element 18. In some embodiments, sleeve 25 is rotatably secured to locking element 18 to enable up to three hundred and sixty degree rotation of sleeve 25 relative to locking element 18 in the direction indicated by arrow 26. It should be understood that locking system 10 may be configured without sleeve 25 such that locking cable 14 is directly secured to locking element 18 or another portion of system 12.

In the embodiment illustrated in FIG. 1, sleeve 25 comprises a joint 30 configured to receive an end 32 of locking cable 14. Locking cable 14 is secured within joint 30 of locking element 18 to enable pivotal movement (e.g., motion around an indefinite number of axes) and rotational movement (e.g., rotation of locking cable 14 about longitudinal axis of cable 14) of locking cable 14 relative to locking element 18. The pivotal and rotational movement of locking cable 14 relative to locking element 18 substantially prevents or eliminates the ability to use cable 14 as a cantilever for additional leverage to detach/pry away locking element 18 from electronic device 10.

FIG. 2 is side view of the locking system 12 of FIG. 1. In the embodiment illustrated in FIG. 2, joint 30 comprises a ball joint 40. Ball joint 40 comprises an opening 42 and a socket or recessed area 44 configured to receive a ball or spherical member 46 disposed on end 32 of locking cable 14. Ball joint 40 enables pivotal movement of cable 14 (i.e., tilting of cable 14 in a plurality of different planes such as, for example, movement at least in the directions indicated by arrows 34a and 34b in a plane parallel with the page upon which FIG. 2 resides and any number of planes extending in/out of the page upon which FIG. 2 resides such as indicated by arrows 36a and/or 36b) and rotational movement of cable 14 (i.e., uniaxial rotation of cable 14 in the direction indicated by arrow 38 about an axis defined by a longitudinal axis of cable 14) relative to locking element 18 via spherical member 46 in ball joint 40. Thus, ball joint 40 enables movement of cable 14 in at least two degrees of freedom (e.g., three degrees of freedom illustrated in FIGS. 1 and 2). Accordingly, ball joint 40 enables freely pivotal and rotational movement of cable 14 about a plurality of directions (e.g., degrees of freedom) so that it can pivot/tilt in at least two planes and uniaxially rotate about an axis of cable 14.

In the embodiment illustrated in FIG. 2, spherical member 46 is coupled to end 32 via an adhesive, crimping or any other method of attachment. However, it should be understood that locking cable 14 may also be configured having spherical member 46 as an integral component thereof (e.g., formed as a unitary and/or one-piece member). Recessed area 44 is generally spherical in shape comprising a radius slightly larger than the radius of spherical member 46 to enable the pivotal and rotational movement of locking cable 14 relative to locking element 18.

According to some embodiments, ball joint 40 is fabricated by an overmolding process. For example, spherical member 46 is fabricated from a steel material and sleeve 25 comprises a zinc casting that is overmolded over spherical member 46 to form ball joint 40. It should be understood that other means of fabrication are available such as, but not limited to, utilizing a press fit to fabricate ball joint 40.

Thus, embodiments of the present invention provide a locking system 12 to reduce theft of electronic devices 10 in which locking system 12 is coupled thereto by providing a pivotal and rotatable connection between locking cable 12 and locking element 18.

1. An electronic device locking system, comprising:
a locking element removeably coupleable to an electronic device; and
a locking cable coupled to the locking element to enable at least three degrees of freedom of movement of the locking cable relative to the locking element.

2. The locking system of claim 1, wherein the locking element comprises a ball joint for receiving the locking cable.

3. The locking system of claim 1, wherein the locking cable is rotatable relative to the locking element.

4. The locking system of claim 1, wherein the locking cable is pivotally coupled to a rotatable sleeve of the locking element.

5. The locking system of claim 1, wherein the locking cable is rotatably coupled to a sleeve of the locking element.

6. The locking system of claim 1, wherein the locking cable comprises an end having a spherical member coupleable to the locking element.

7. The locking system of claim 1, wherein the locking cable comprises an end having a spherical member coupleable to a sleeve of the locking element.

8. A method of manufacturing an electronic device locking system, comprising:
providing a locking element removeably coupleable to the electronic device; and
coupling a locking cable to the locking element to enable at least three degrees of freedom of movement of the locking cable relative to the locking element.

9. The method of claim 8, further comprising providing a ball joint on the locking element for receiving the locking cable.

10. The method of claim 8, further comprising rotateably coupling the locking cable to the locking element.

11. The method of claim 8, further comprising pivotally coupling the locking cable to a rotatable sleeve of the locking element.

12. The method of claim 8, further comprising rotatably coupling the locking cable to a rotatable sleeve of the locking element.

13. The method of claim 8, further comprising coupling a spherical member disposed on an end of the locking cable to the locking element.

14. The method of claim 8, further comprising coupling a spherical member disposed on an end of the locking cable to a sleeve of the locking element.

15. An electronic device locking system, comprising:
lockable means removably coupleable to an electronic device; and
cable means coupled to the lockable means to enable at least three degrees of freedom of movement of the cable means relative to the lockable means.

16. The locking system of claim 15, wherein the lockable means comprises a ball joint for receiving the cable means.

17. The locking system of claim 15, wherein the cable means is pivotally coupled to a rotatable sleeve means of the lockable means.

18. The locking system of claim 15, wherein the cable means is rotatably coupled to a rotatable sleeve means of the lockable means.

19. The locking system of claim 15, wherein the cable means comprises an end having a spherical means coupleable to the lockable means.

20. An electronic device locking system, comprising:
a locking element removeably coupleable to an electronic device;
a sleeve coupled to the locking element; and
a locking cable coupled to the locking element to enable at least two degrees of freedom of movement of the locking cable relative to the sleeve.

21. The locking system of claim 20, wherein the sleeve comprises a ball joint for receiving the locking cable.

22. The locking system of claim 20, wherein the locking cable is rotatable relative to the sleeve.

23. The locking system of claim 20, wherein the sleeve is rotatable relative to the locking element.

24. The locking system of claim 23, wherein the locking cable is pivotally coupled to the sleeve.

25. The locking system of claim 20, wherein the locking cable comprises an end having a spherical member coupleable to the sleeve.
